(19) United States
(12) Patent Application Publication
(10) Pub. No.: US 2008/0185296 A1
(43) Pub. Date: Aug. 7, 2008

(54) Planar Device With Well Addressing Automated By Dynamic Electrowetting

(75) Inventors: Fabien Sauter-Starace, Seyssinet-Pariset (FR); Yves Fouillet, Voreppe (FR); Nathalie Picollet-D'Hahan, La Ferriege (FR); Francois Chatelain, Beaulieu (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/916,751

(22) PCT Filed: Jun. 7, 2006
(86) PCT No.: PCT/FR2006/050534

§ 371 Date: Dec. 6, 2007

(30) Foreign Application Priority Data
Jun. 9, 2005 (FR) 0551557

(51) Int. Cl. G01N 27/26

(52) U.S. Cl. 205/777.5; 204/403.01

(57) ABSTRACT

The invention concerns a method to analyse the liquid in a drop (2), comprising:
contacting a drop of this liquid with a hydrophobic surface (8),
displacing the drop on this surface by electrowetting, to bring it to a site (24, 26, 28) to measure electrical activity in which a conductive solution (42) is arranged,
measuring said electrical activity.

### TECHNICAL AREA AND PRIOR ART

The present invention relates to a method and device for measuring the electrical activity of one or more biological cells, and particularly to a device allowing the measurement in parallel of the electrical activity of a plurality of biological cells.

To study the electrical activities of cells, the <<patch-clamp>> technique was proposed by Sakmann and Neher in 1981. More recently, research has been made into alternatives to increase the success rate of this measurement and to increase the quantity of accessible data.

Document WO04/038409 describes a device to perform such measurements. This device is of planar type, in silicon.

The fabricated chip uses a system of conduits enabling the suction of fluids. More precisely, this device comprises channels intended to be connected to capillaries, themselves connected to liquid suction means positioned outside the chip. The system is therefore complex and non-compact.

Additionally, the aspirated volumes are difficult to control and are of substantial size, in the order of a few microlitres.

In this type of device, the fluid volumes are determined by cavities, made in silicon for example, or by polymers which achieve sealing of the lower and upper chambers. Each measuring site therefore has to be filled individually with a solution suitable for measuring the electrical activity of the ionic channels and comprising a cell suspension. The volume of fluid, here again, is large and miniaturisation is limited by dispensing equipment standards. This constraint also limits integration possibilities since each site must be accessible to macroscopic dispensing means.

Document WO 02/03058 describes a device in which the liquid samples are transported continuously in a channel and brought to a measurement site of <<patch clamp>> type. This site is itself provided with suction conduits and pumps to position the fluid volumes to be analysed therein.

All these devices use channels and capillaries.

These elements raise certain technical problems however: the fluid volumes are large, which is especially penalising if very costly products are used such as toxins or medicinal products or other active ingredients. Connection difficulties also arise, as well as chamber electrical insulation problems, sealing problems and even fragility with regard to the capillaries. There is also a risk of clogging with cell clustering or sedimentation.

The problem is therefore raised of providing a more compact device, allowing smaller fluid volumes to be measured, particularly in the order of one picolitre.

The problem is additionally raised of integrating functions, such as the transport of the fluid volumes to be analysed, with the means enabling analysis of these fluids.

### DESCRIPTION OF THE INVENTION

The invention firstly concerns a method to analyse a drop of a liquid medium comprising:
contacting a drop of liquid with a hydrophobic surface,
moving this drop on this surface by electrowetting, to bring it to a site where electrical activity is measured, in which a conductive solution is arranged,
measuring said electrical activity.

According to one embodiment, the measurement site of electrical activity is devoid of a hydrophobic layer and has a hydrophilic layer and first and second measurement means of electrical activity, the first measurement means of electrical activity being arranged on the hydrophilic layer.

According to one embodiment, the drop may be confined, at least when it is being moved, between said hydrophobic surface and an upper substrate.

Before deformation, the drop may or may not be confined by the upper substrate.

Advantageously, displacement is achieved by activating a plurality of electrodes positioned underneath the hydrophobic layer.

The drops of liquid to be analysed may be formed from one or more reservoirs.

The invention also concerns a device to analyse a drop of a liquid medium comprising:
a first substrate comprising a hydrophobic layer,
means forming at least one analysis site or electrical activity measurement site,
means to move a drop on this surface by electrowetting, to bring the drop to said analysis site.

A second substrate can be arranged opposite the hydrophobic layer, allowing a closed configuration to be formed.

This second substrate may also comprise a superficial hydrophobic layer and optionally an electrode.

The means to displace the drop on the hydrophobic layer by electrowetting advantageously comprise a plurality of electrodes underneath this hydrophobic layer.

At least one analysis site or electrical activity measurement site is devoid of a hydrophobic layer, and has a hydrophilic layer and means to measure electrical activity. The first means to measure electrical activity are then arranged on the hydrophilic layer.

A cover or substrate, together with the device, may form a chamber which communicates via an orifice of the hydrophilic layer with the surface of the hydrophobic layer.

At least one of the analysis sites or electrical activity measurement sites may be surrounded by a portion of hydrophobic layer.

The volume of the drops may range from 1 pl to 10 μl for example.

Measurement of electrical activity may be performed on a single cell contained in the drop. This may entail measurement on a cell channel.

The drop may contain different types of cells, or at least one type of cell and one type of toxin.

According to one particular embodiment, at least one substance e.g. an active agent such as a freeze-dried drug is arranged on the pathway of the drop towards a measurement site. Mixing of the substance with the liquid of the drop may then take place when the drop arrives in contact with said substance. This mixture can then be brought to the measurement site.

At least one reservoir may be provided to store a liquid to be analysed or whose electrical activity is to be measured.

Means allow a drop of liquid to be formed from said reservoir.

If there are a plurality of analysis or measurement sites, at least one reservoir common to this plurality of analysis or measurement sites may be provided to form drops which can be brought to different analysis sites of this plurality of analysis sites.

The invention also concerns a device comprising a matrix of electrophysiological measurement sites on a substrate provided with means to bring drops of liquids to be analysed to the measurement sites, e.g. drops of physiological buffer containing cells or medicinal products.

These drops may therefore be brought automatically from one or more reservoirs.

According to the present invention, the method for dispensing fluids (cell suspension, drugs, flushing liquids) uses the displacement of drops by dynamic electrowetting on a dielectric, contrary to continuous flow displacements in channels as in digital microfluidics.

The invention concerns a method and a device allowing electrophysiological measurements to be performed, using dynamic electrowetting of a very low quantity of reagents. Two or more reservoirs can be provided.

The pitch of these reservoirs may be the pitch of a well plate.

From these reservoirs, series of drops can be generated and transported in controlled manner, so as first to bring the cell suspensions to the measurement wells and then the drugs whose impact it is desired to measure on the behaviour of the ionic channels.

### BRIEF DESCRIPTION OF THE FIGURES

FIGS 1A-1C illustrate the principle of drop displacement, by electrowetting.

FIG. 2 shows a closed configuration of a drop displacement device.

FIGS. 3A and 3B show a mixed configuration of a drop displacement device.

FIGS. 4 and 5A-5B show a drop displacement device, in which the upper cover is provided with an electrode.

FIG. 6 is an overhead view of a device according to the invention, with several measurement sites.

FIG. 7 is a detailed view of a measurement site in a device of the invention.

FIGS. 8A-8D show a well to hold a liquid, or a liquid reservoir.

FIGS. 9A-9C illustrate the steps of a method using a freeze-dried drug.

### DETAILED DESCRIPTION OF PARTICULAR EMBODIMENTS

A system according to the invention uses a device to displace or manipulate liquid drops, by electrowetting, and means to measure the electrical activity of the liquid contained in these drops or of cells contained in these drops.

These means comprise a site, or a well, in which measurement of this activity, using means of electrode type, can be performed.

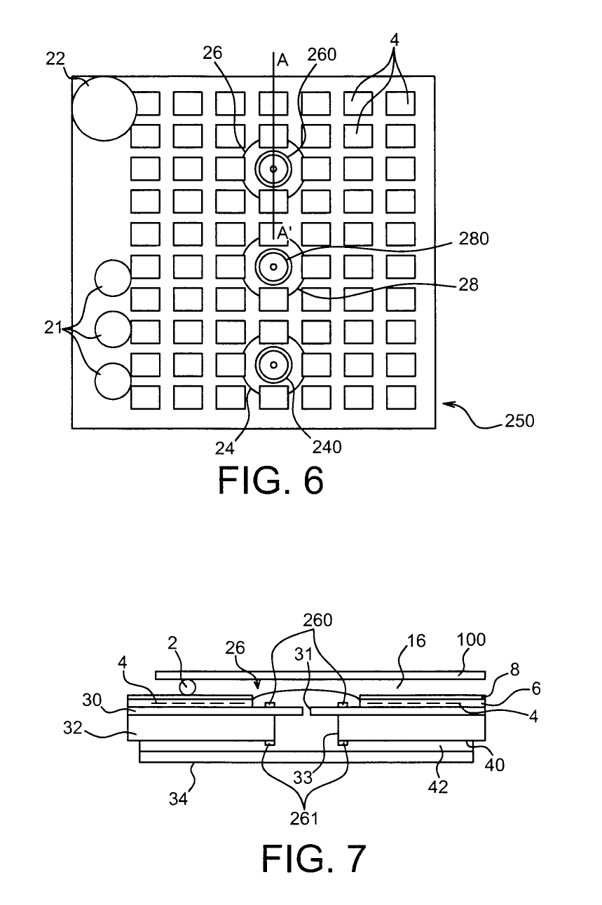

A device according to the invention is schematically shown in an overhead view in FIG. 6. Measurement sites 24, 26, 28 can be seen arranged on, or integrated in, a plate 250 for the manipulation and transport of the drops by electrowetting.

The device obtained is therefore compact, allowing the formation and transport of small volumes of liquid to measurement sites, and therefore not requiring means such as fluid suction conduits.

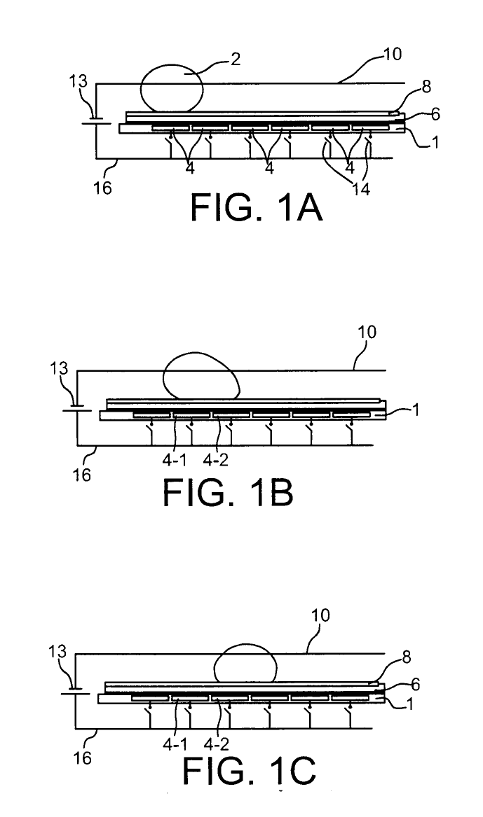

A first embodiment of a drop transport and manipulation device used under the present invention, of open-system type, is illustrated FIGS. 1A-1C.

This embodiment uses a device to transport or manipulate liquid drops based on the principle of electrowetting on dielectric.

Examples of said devices are described in the article by M. G. Pollack, A. D. Shendorov, R. B. Fair, titled <<Electro-wetting-based actuation of drops for integrated microfluidics>>, Lab Chip 2 (1) (2002) 96-101.

The forces used to displace liquid drops are therefore electrostatic forces.

Document FR-2 841 063 describes a device which, inter alia, uses a catenary lying opposite the activated electrodes for this displacement.

The principle behind this type of displacement is summarized FIGS. 1A-1C.

A drop 2 rests on an electrode network 4, from which it is insulated by a dielectric layer 6 and a hydrophobic layer 8 (FIG. 1A). This gives a hydrophobic, insulating stack.

The hydrophobic nature of this layer means that the drop has an angle of contact on this layer of more than 90°.

The electrodes 4 are themselves formed on the surface of a substrate 1.

When the electrode 4-1 located in the vicinity of the drop 2 is activated, using switching means 14 whose closure sets up a contact between this electrode and a voltage source 13 via a common conductor 16, the dielectric layer 6 and the hydrophobic layer 8 between this activated electrode and the drop to which a voltage is applied, act as a capacitor.

The counter-electrode 10 allows possible displacement by surface electrowetting of the hydrophobic surface; it maintains an electric contact with the drop during said displacement. This counter-electrode can either be a catenary as in FR-2 841 063, or a buried wire, or a planar electrode in the cover of a confined system (said confined system is described further on).

In an open system, if there is no displacement, it is possible to spread the drop on the hydrophobic surface, with no counter-electrode. This is the case for example if the drop can be transported on the hydrophobic surface by a conventional dispensing system, the electrodes 4-1, 4-2 solely being used to spread or deform the drop at the point where it was deposited.

The drop can therefore optionally be displaced step by step (FIG. 1C), on the hydrophobic surface 8, by successive activation of electrodes 4-1, 4-2, . . . etc, along the catenary 10.

It is hence possible to displace liquids, but also to mix them (by causing drops of different liquids to draw together), and to determine complex protocols.

The above-cited documents give examples of the use of series of adjacent electrodes to manipulate a drop in a plane, the electrodes possibly being arranged in a linear fashion, but also in two dimensions thereby defining a plane of displacement of the drops.

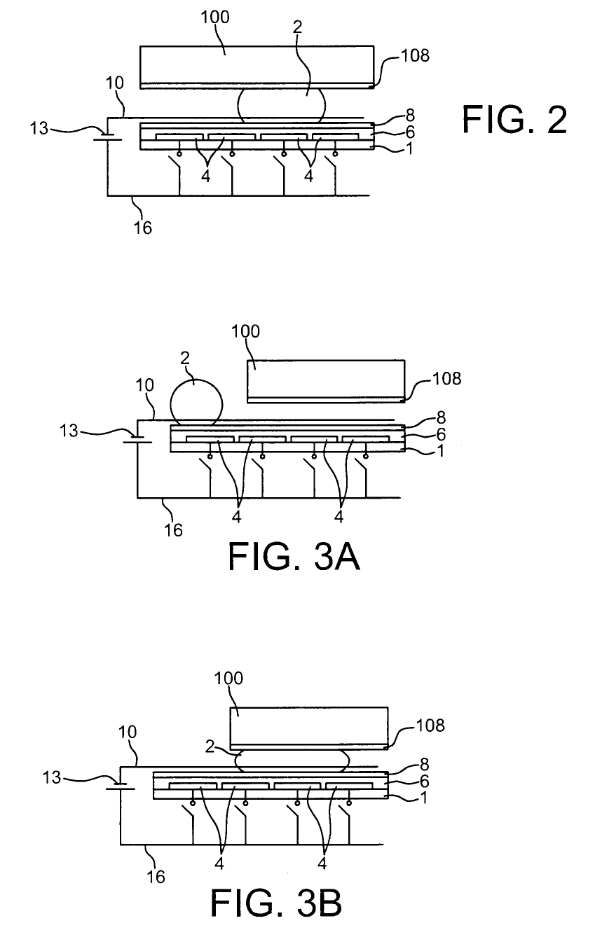

FIG. 2 shows another embodiment of a device to transport or manipulate drops, which can be used under the invention, of closed or confined system type.

In this figure, identical reference numbers to those in FIGS. 1A-1C designate the same parts.

This device additionally comprises an upper substrate 100, preferably also coated with a hydrophobic layer 108. This assembly can optionally be transparent to allow overhead viewing.

FIGS. 3A and 3B, in which identical reference numbers to those in FIG. 2 designate identical or similar elements, show a mixed drop transport or manipulation system, in which a drop 2 is initially in an open medium (FIG. 3A), the activation of electrodes 4-1, 4-2, 4-3 allowing the drop to be flattened (FIG. 3B), in a closed system, in a zone in which the system is provided with a cover, as described above with reference to FIG. 2.

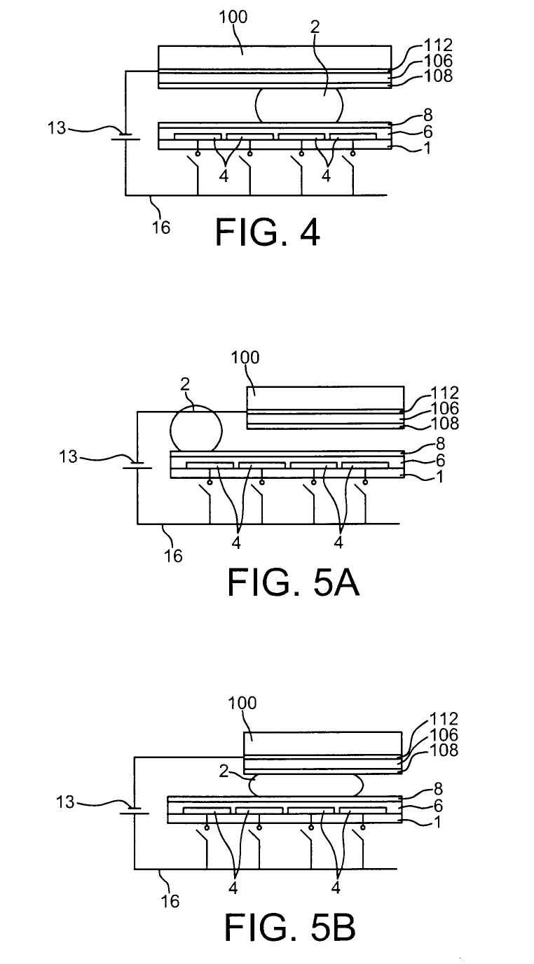

FIG. 4 shows a variant of the closed system, with a conductive cover 100, comprising an electrode or a network of electrodes 112, and possibly an insulation layer 106 (this layer is optional) and a hydrophobic layer 108.

The catenary 10 of the preceding figures, in this embodiment, is replaced by electrode 112. Activation of this electrode 112 and of electrodes 4 allows the drop to be moved to the desired position, then to draw it out or deform it.

FIGS. 5A and 5B, in which identical reference numbers to those in FIG. 4 designate identical or similar elements, show a mixed system in which a drop 2 is initially in an open medium (FIG. 5A), the activation of electrodes 4-1, 4-2, 4-3 allowing the drop to be flattened (FIG. 5B), in a closed system, in a zone in which the system is provided with a cover, as described above with reference to FIG. 4.

A device according to the invention may also comprise means which can be used to command or activate the electrodes 4, e.g. a computer of PC type and a relay system connected to the device or to the chip, such as relays 14 in FIG. 1A, these relays being piloted by the PC-type means.

Typically, the distance between a possible conductor 10 (FIGS. 1A-5B) and the hydrophobic surface 8 is between 1 μm and 10 μm for example, or between 1 μm and 50 μm.

This conductor 10 may be in the form of a wire having a diameter of between 10 μm and a few hundred μm, e.g. 200 μm. This wire may be a gold or aluminium wire, or in tungsten or any other conductive material.

When two substrates 1, 100 are used (FIGS. 2-5B), they are spaced apart by a distance of between 10 μm and 100 μm for example or 500 μm.

Irrespective of the embodiment considered, a drop of liquid 2 may have a volume for example of between 1 picolitre and a few microlitres e.g. between 1 pl and 100 pl or 1 μl or 5 μl or 10 μl.

Also each of the electrodes 4 can have a surface in the order of a few dozen μm² for example (e.g. 10 μm²) up to 1 mm², depending on the size of the drops to be transported, the space between neighbouring electrodes being between 1 μm and 10 μm for example.

The structuring of the electrodes 4 may be achieved using conventional micro-technologies e.g. photolithography.

Methods to fabricate chips incorporating a device of the invention may be directly derived from the methods described in document FR-2 841 063.

Conductors, in particular conductors 110 can be fabricated by depositing a conductor layer and etching this layer following a suitable conductor pattern, before depositing the hydrophobic layer 108.

The electrodes can be fabricated by deposits of a metal layer (e.g. a metal chosen from among Au, Al, ITO, Pt, Cr, Cu) by photolithography. The substrate is then coated with a dielectric layer, e.g. in Si₃N₄ or SiO₂. Finally a deposit of a hydrophobic layer is made, for example a Teflon deposit made by spin coating.

Said device to displace drops may use a two-dimensional network of electrodes which, step by step, will allow the moving of liquids in or on a plane, and their mixing to achieve complex protocols.

In the embodiment with catenaries 10 (FIGS. 1A-3B), a two-dimensional assembly (2D) of these catenaries can be placed above the 2D assembly of electrodes. In the embodiment with a counter-electrode 112 incorporated in the cover 100 (FIGS. 4-5B), this counter-electrode can also have a two-dimensional structure.

FIG. 6 shows a device according to the invention, with measurement sites or chambers.

This device firstly comprises a two-dimensional device to transport and manipulate drops, e.g. of the type such as described above, of which only the electrodes of the lower substrate are schematically shown and are again designated by reference 4.

References 22 and 21 designate several reservoirs e.g. a reservoir of cells 22 and one or more reservoirs of drugs or active agents 21. The term <<active agent>> is used to designate a toxin or drug.

A single reservoir may be sufficient in some cases. It is also possible not to use a reservoir and to bring the volumes of liquid to be analysed by other means e.g. a pipette.

The system may also comprise a single measurement site 26 or a plurality of sites 24, 26, 28.

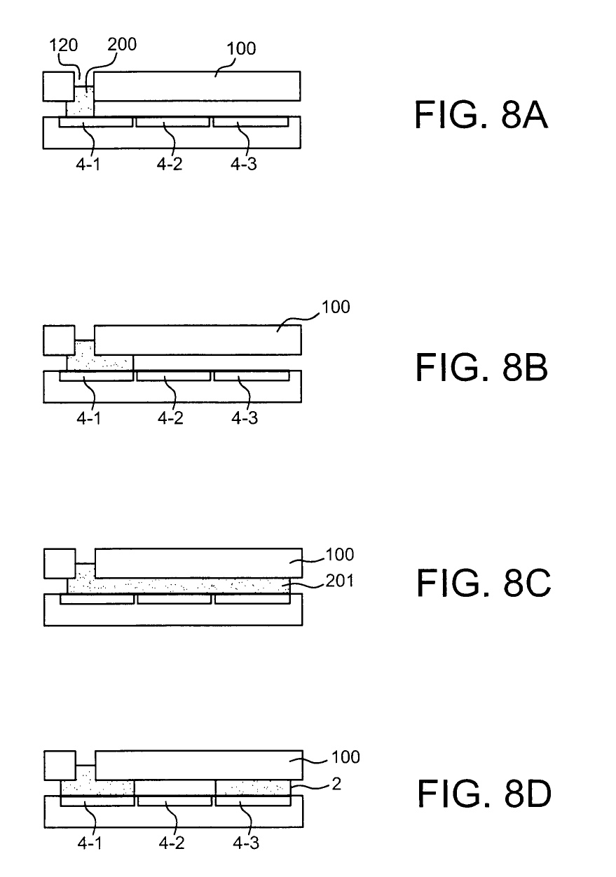

The reservoirs 21, 22 are advantageously compatible with a format of well plates (8, 96, 384, 1586 wells). They are advantageously integrated in the device. An example of embodiment of these reservoirs is given below with reference to FIGS. 8A-8D.

FIG. 7 shows a portion of the device in FIG. 6, in the vicinity of a measurement well 26, in cross-section along an axis AA′.

The lower substrate is provided with its activation electrodes 4, whilst the upper substrate 100 is shown in simplified manner without its counter-electrode.

The drop displacement structure described above rests on a hydrophilic substrate or layer 30 having a thickness of between 0.1 μm and 20 μm, for example a dielectric such as SiO₂ or Si₃N₄.

The electrodes for displacement by electrowetting may be fabricated on this layer 30.

This substrate or this layer comprises an opening 31, a few μm in diameter, for example between 1 μm and 2 μm or 5 μm. This opening is made by lithography for example and selective etching. In relation to the diameters and depths to be etched, combined dry/wet etching can be used (gas attack [e.g. SF₆] in a plasma) or wet etching (using a solution of HF or H₃PO₄ for example).

This substrate or this layer 30 rests on a substrate 32 having a thickness of between 100 μm and 1 mm for example, e.g. in silicon, glass or a polymer which itself has an opening 33 which is wider than opening 31.

A lower substrate or cover 34, e.g. in polycarbonate or epoxy, or a printed circuit, together with substrate 32, defines a chamber 40 able to contain a liquid 42, in particular a conductive solution such as PBS (<<phosphate buffered saline>>).

This liquid 42 may have been previously brought drop by drop, by electrowetting, similar to the manner in which drops 2 are subsequently brought for measurement.

A rear face measurement electrode 261 can be placed against substrate 32 or against substrate 30 so that it contacts a liquid 42 present in the cavity 40. This electrode, together with electrode 260, will be used to apply a potential difference in the liquid medium 42 present in the cavity. Conductors, not shown in the figure, allow the desired voltage to be applied between the two electrodes 260, 261. This voltage is piloted or commanded for example by the means used to command or activate electrodes 4, e.g. a PC-type computer having suitable interfaces. These conductors also allow measurement of the variation in voltage between the electrodes 260, 261 when a drop of liquid is brought by electrowetting onto the measurement site and is mixed with the liquid 42. This variation can be stored in memory means of a device which is subsequently used to process and analyse the data collected at the time of measurement.

With measurements of <<patch clamp>> type, it is rather more cells which are brought inside a drop to a measurement site, the electrodes 260, 261 allowing a measurement to be taken on an individual cell.

From the reservoir containing the drug to be tested or the physiological buffer which contains the cells, calibrated drop 2 are formed by dynamic electrowetting, in <<covered>> configuration (FIGS. 2-5B) or non-covered (FIGS. 1A-1C).

As already indicated, it is also possible to deposit drops on the device using means such as a pipette.

The drops 2 are displaced in a non-conductive medium 16, e.g. oil or air.

According to one example of use, the measurement chambers or sites 24, 26, 28 are firstly filled with conductive physiological solutions containing cells brought from reservoir 22 for example. The nano-drops of drugs are created, for example from reservoirs 21, which are transported by electrowetting towards the measurement sites 240, 260, 280.

The displaced or transported drops may consist of a conductive solution (buffer solution for the cells) or non-conductive. The drugs, or active agents, may be diluted in solutions of low conductivity (magnitude of a few mS/m, e.g. 1 mS/m) but the liquid of the drop at the measurement site has a conductivity in the order of 1 Siemens/m or between 0.5 Siemens/m and 2 Siemens/m.

As already indicated above, the electrodes 4 used for electrowetting, and the electrodes 260 used for electrophysiological measurement, lie on a dielectric membrane 1,30 whose coating 6,8 is hydrophobic and passivated in the drop displacement areas.

On the other hand, in the measurement zones such as zones 26, the coating (in fact: layer 30) is hydrophilic and non-passivated, the measurement electrode 260 being in contact with the liquid of the conductive solution 42. A drop 2, brought to the measurement site 26, will modify the properties of the liquid positioned on this site.

According to the invention, one or more measurement chambers are made or integrated in a device to transport drops by electrowetting. Electrowetting allows drops to be transported to these chambers. Pumping means ensure a negative pressure between the upper chamber and the lower chamber, so as to capture a cell on orifice 31.

For the electric insulation of a membrane fragment, the cells—in a drop—are brought to one of the measurement chambers by electrowetting. When the cells sediment, the pressures between the chamber 40 and that part of the device located on the side of electrodes 260 are modified; in this manner a negative pressure is set up between the lower and upper chambers. The cells are therefore attracted towards the (single) orifice 31 of the dielectric membrane 30. A single cell will finally be analysed. Once the cell membrane lies on the hole 31, it deforms and invaginates inside the hole. The electric resistance measured at the cell/dielectric contact point 30 may then be in the order of a Giga-Ohm. This resistance is used to visualize currents, e.g. on a <<patch>> amplifier, in the order of a pico-ampere. These currents result from the passing of ions through the channel proteins of the cell.

FIGS. 8A-8D show how a reservoir can be fabricated, such as reservoir 21 or reservoir 22.

A liquid 200 to be dispensed is deposited in a well 120 of this device (FIG. 8A). This well is fabricated for example in the upper cover 100 of the device. The lower part, shown schematically FIGS. 8A-8D, is similar for example to the structure in FIGS. 1A-1C. If a configuration with upper cover is not used, the open configuration leaves open the possibility to pour a liquid such as oil over the entire surface. A drop can then be dispensed and moved by electrowetting.

Three electrodes 4-1, 4-2, 4-3, similar to electrodes 4 to displace liquid drops, are shown FIGS. 8A-8D.

The activation of this series of electrodes 4-1, 4-2, 4-3 leads to the spreading of a drop from well 120, and hence to a liquid segment 201 as illustrated on FIG. 8C.

Next, this liquid segment is cut by de-activating one of the activated electrodes (electrode 4-2 in FIG. 8C). In this manner a drop 2 is obtained, as illustrated on FIG. 8D.

A series of electrodes 4-1, 4-2, 4-3 is therefore used to draw liquid from the reservoir 120 in a finger 201 (FIGS. 8B and 8C) then to cut this finger of liquid 201 (FIG. 8D) so as to form a drop 2 which can be transported towards any measurement site as described above.

This method can be applied by inserting electrodes such as electrodes 4-1 between the reservoir 120 and one or more electrodes 4-2 called cutting electrodes.

The invention offers multiple advantages.

First, it allows a single dispensing, from a reservoir, of drugs and cells, or any active agent, instead of well-by-well dispensing as in known planar patch clamp devices.

It also allows the use of extremely reduced volumes of reagent, in the order of a picolitre (e.g. between 0.5 pl and 1 μpl or 2 pl or 5 pl), with no dead volume, together with control over concentrations. In addition, there is no evaporation which could risk influencing the viability of the cells.

The measurement zones are electrically insulated in the upper chamber and lower chamber. The wells have electrical independence, which means that test conditions (drugs, buffer and cells) are strictly independent.

It is possible to sample quantities of drug from the reservoirs with variable increment, e.g. in the order of 64 nanolitres and with control over concentrations. Concentration is controlled by successive dilutions from a reservoir of known concentration.

The possibility may also be mentioned of changing buffer 42 and/or electrodes to study channels other than BK channels on wild or diseased cells. BKs are potassium channels which can be over-expressed in genetically modified cells. An optimal conductor solution 42 is achieved when giving consideration to the type of channel and the set of electrodes 260, 261 used.

It is also possible to study cycles for toxins having reversible effects. The toxins of interest will have an inhibiting or activating effect on the channel proteins. This effect may be reversible; for example by reducing toxin concentration in the conductor solution, channel activity will gradually be restored (the number of inhibited channels will decrease).

It is also possible to study the combined actions of toxin mixtures, to verify whether or not their actions are or are not compatible and/or synergic.

According to another example of use, it is possible to cause the cells to roll at the bottom of the drop 2, to increase <<capture>> probability. One of the difficulties with the planar <<patch clamp>> is related to the capture of a cell on the orifice 31 in the cell membrane 30. This probability of capture is increased by moving or shaking the drops. Drop shaking is kept moderate to limit problems arising out of undue adhering.

Another example of application is the possibility to place freeze-dried toxins, stored in oil, on the chip. A drop 2 of buffer solution is transported towards the freeze-dried toxin to place it in solution. The drop of toxin thus formed is fused with another drop 2 containing the cells. Up until now toxins were <<brought>> to the measurement chamber in drops from a fluid reservoir. Here the freeze-dried toxins, in the form of pellets kept in oil, can be brought onto the chip to a separate site from the measurement site and re-placed in solution by contacting with a drop.

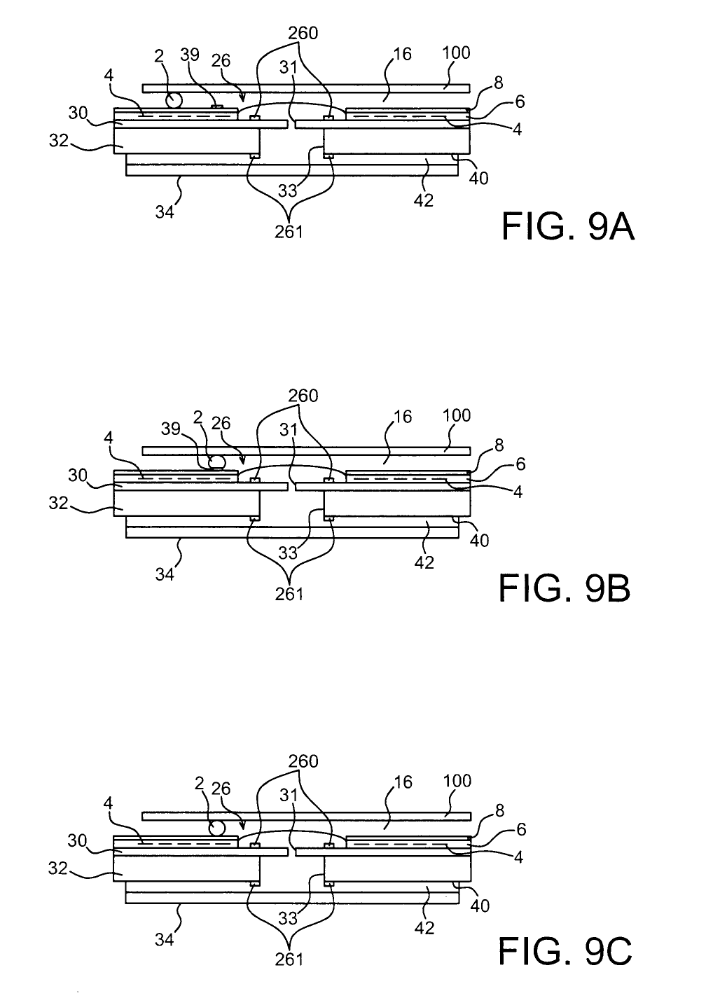

FIGS. 9A-9C show the steps of a method using a freeze-dried drug.

In these figures, identical reference numbers to those in FIG. 7 designate identical or similar elements.

A freeze-dried drug 39 is arranged on the pathway of a drop 2 in the direction of a measurement site (FIG. 9A).

When it arrives on the freeze-dried drug 39, the drop remains stationary for approximately a few seconds, which will allow the drug to be placed in solution in the drop (FIG. 9B).

Then the drop containing the drug in solution is transported towards the measurement site (FIG. 9C).

In these FIGS. 9A-9C, a single freeze-dried drug 39 is shown, but there may be several freeze-dried pellets of different types. The drop can be directed, e.g. by its pathway via electrowetting, towards the chosen pellet.

It is hence possible to modify the type of buffer in place at a measurement site. It is therefore possible in particular to inhibit or activate ionic channels of the cell membrane.

It is possible, using an adapted method, to minimize adhering of the cells on the dielectric 30. For example grafts of polyethylene glycol allow the hydrophobic adsorption of proteins to be limited (see article by B. Balkrishnan et al., Biomaterials, vol. 26, p. 3495-3502).

Generally, with the invention it is possible to conduct measurements of <<patch-clamp>> type on a volume in the order of a picolitre (between 0.5 pl and 5 pl for example, e.g. 1 pl or 2 pl), which is smaller by several orders of magnitude than the volumes needed for known devices.

Electrophysiological measurements according to the invention can be made on cells such as oocytes, but also on biological particles in suspension or on lipid vesicles (such as liposomes) or on corpuscles or bacteria or viruses or cell nuclei, or a mixture thereof.

Amongst transportable active agents, mention may be made of DNA/RNA strands, or nucleotides or enzymes or proteins or parasites or bacteria or viruses or pollens or polymers, or insoluble solid particles such as dielectric or conductive or magnetic particles, or pigments or dyes or powders or polymer structures or insoluble pharmaceutical substances.

1-24. (canceled)

25. A method to analyze a liquid in a drop, comprising:
contacting a drop of the liquid with a hydrophobic surface;
moving the drop over the hydrophobic surface by electrowetting, to bring the drop to a site to measure electrical activity, in which a conductive solution is arranged; and
measuring the electrical activity.

26. A method according to claim 25, the drop being confined, at least when the drop is being moved, between the hydrophobic surface and an upper substrate.

27. A method according to claim 26, the drop not being confined by the upper substrate.

28. A method according to claim 26, the drop being confined by the upper substrate.

29. A method according to claim 25, using an electrowetting device comprising a first substrate coated with the hydrophobic layer, and a plurality of electrodes arranged underneath the hydrophobic layer, the moving being achieved by activating the electrodes.

30. A method according to claim 25, the drop being formed from one or more reservoirs.

31. A method according to claim 25, the drop having a volume of between 1 pl and 10 μl.

32. A method according to claim 25, the measuring electrical activity being performed on a single cell contained in the drop.

33. A method according to claim 32, the measuring being a measurement on one cell channel.

34. A method according to claim 25, the drop containing cells of different types or at least one type of cell and one type of toxin.

35. A method according to claim 25, including at least one freeze-dried substance arranged on a pathway of the drop towards the site to measure.

36. A device to analyze a drop of a liquid medium, comprising:
a first substrate comprising a hydrophobic layer;
at least one analysis site to measure electrical activity;
means to move a drop, on the hydrophobic surface, by electrowetting to bring the drop to the analysis site.

37. A device according to claim 36, further comprising a second substrate, arranged facing the hydrophobic layer.

38. A device according to claim 37, the second substrate comprising a superficial hydrophobic layer.

39. A device according to claim 37, the second substrate comprising an electrode.

40. A device according to claim 37, the means to move the drop, on the hydrophobic layer by electrowetting, comprising a plurality of electrodes underneath the hydrophobic layer.

41. A device according to claim 37, the at least one analysis site being devoid of a hydrophobic layer, and including a hydrophilic layer and first and second means to measure electrical activity.

42. A device according to claim 41, wherein a cover or substrate, together with the device, forms a chamber in communication via an orifice of the hydrophilic layer, with the surface of the hydrophobic layer.

43. A device according to claim 42, further comprising pumping means to generate negative pressure in the chamber.

44. A device according to claim 37, the at least one analysis site being surrounded by a portion of the hydrophobic layer.

45. A device according to claim 37, further comprising at least one reservoir to store a liquid to be analyzed or whose electrical activity is to be measured.

46. A device according to claim 45, further comprising means to form a drop of liquid from the reservoir.

47. A device according to claim 37, comprising a plurality of analysis sites.

48. A device according to claim 45, comprising a plurality of analysis sites, and at least one reservoir common to the plurality of analysis sites, to form drops to be transported to different analysis sites of the plurality of analysis sites.

49. A device to analyze a drop of a liquid medium, comprising:
a first substrate comprising a hydrophobic layer,
at least one analysis site to measure electrical activity, the at least one analysis site being devoid of a hydrophobic layer, and including a hydrophilic layer and first and second electrodes to measure electrical activity; and
means to move a drop, on the hydrophobic layer, by electrowetting to bring the drop to the analysis site.

50. A device according to claim 49, the first electrode being on the hydrophilic layer.
